(19) United States
(12) Patent Application Publication
(10) Pub. No.: US 2019/0130170 A1
(43) Pub. Date: May 2, 2019

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Tomoyuki Makihira, Tokyo (JP)

(21) Appl. No.: 16/168,634

(22) Filed: Oct. 23, 2018

(30) Foreign Application Priority Data
Oct. 30, 2017 (JP) 2017-209376

(51) Int. Cl. G06K 9/00; G06F 3/01; G06T 7/50; G06T 7/246

(52) U.S. Cl. CPC G06K 9/00281; G06F 3/013; G06T 7/246; G06K 9/00671; G06T 7/50

(57) ABSTRACT

An image processing apparatus includes an information generation unit configured to generate motion contrast information about substantially a same region of an eye to be examined by using a plurality of pieces of tomographic information obtained by imaging substantially the same region at a predetermined time interval, and an information acquisition unit configured to obtain information about a change in a motion contract value of at least part of substantially the same region by using a plurality of pieces of motion contrast information at different times.

### BACKGROUND

### Field of the Disclosure

The present disclosure relates to an image processing apparatus, an image processing method, and a storage medium.

### Description of the Related Art

Angiography using optical coherence tomography (OCT), called OCT angiography (hereinafter, referred to as OCTA), has been discussed in recent years. Such an angiographic method includes calculating blood vessel and blood flow information called motion contrast (hereinafter, referred to as motion contrast (MC) value) which effectively displays blood vessels and blood flows from a plurality of OCT signals in the same region, and displaying the result as an image. The MC value can be calculated by various methods. Known techniques include one using variations in phase caused by a blood flow (Japanese Unexamined Patent Application Publication (Translation of PCT Application) No. 2015-515894), one for detecting temporal fluctuations in signal intensity, and one using phase information.

### SUMMARY

According to an aspect of the present invention, an image processing apparatus includes an information generation unit configured to generate motion contrast information about substantially a same region of an eye to be examined by using a plurality of pieces of tomographic information obtained by imaging substantially the same region at a predetermined time interval, and an information acquisition unit configured to obtain information about a change in a motion contract value of at least part of substantially the same region by using a plurality of pieces of motion contrast information at different times.

Further features of the present invention will become apparent from the following description of exemplary embodiments with reference to the attached drawings.

### BRIEF DESCRIPTION OF THE DRAWINGS

FIGS. 1A and 1B are schematic diagrams illustrating a configuration and driving wiring of a spectral domain optical coherence tomography (SDOCT) apparatus used in an exemplary embodiment.

FIGS. 2A and 2B are schematic diagrams illustrating a scan pattern.

FIGS. 3A and 3B are flowcharts for motion contrast (MC) value change acquisition and optical coherence tomography angiography (OCTA) image acquisition.

FIG. 4 is a flowchart for OCTA image (MC value image) acquisition.

FIGS. 5A and 5B are flowcharts for OCTA image registration and MC value change acquisition.

FIGS. 6A, 6B, and 6C illustrate an obtained OCTA image and continuously-obtained OCTA images.

FIGS. 7A, 7B, and 7C illustrates a feature point extraction image, a plurality of OCTA images after position correction, and an MC value change graph.

FIGS. 8A, 8B, and 8C illustrate MC value change two-dimensional maps and composition examples of OCTA images.

FIGS. 9A, 9B, 9C, 9D, 9E, 9F, 9G, and 9H illustrate display examples of MC value change images and MC value change amounts.

FIGS. 10A, 10B, 10C, 10D, and 10E illustrate setting examples of MC value change statistics calculation areas.

FIGS. 11A, 11B, 11C, 11D, and 11E illustrate display examples of MC value change diagrams and luminance change areas on blood vessels.

FIGS. 12A, 12B, and 12C illustrate a modification of the settings of the MC value change statistics calculation areas.

FIGS. 13A, 13B, 13C, and 13D are diagrams illustrating OCTA images with different depth range specifications.

FIGS. 14A and 14B illustrate a display example of a temporal change of an MC value change diagram.

### DESCRIPTION OF THE EMBODIMENTS

Conventional OCTA techniques only display blood vessels in a static manner by calculating and imaging MC values from OCT luminance signals. There has been no known technique focused on dynamic changes and variations in the MC value of each pixel, i.e., that provides dynamic change information about a blood flow by obtaining a plurality of OCTA images and analyzing and displaying changes in the MC values which are respective pixel values. An exemplary embodiment of the present invention is directed to providing dynamic change information about a blood flow.

According to an aspect of the present exemplary embodiment, an image processing apparatus includes an information generation unit configured to generate MC information about substantially a same region of an eye to be examined by using a plurality of pieces of tomographic information obtained by imaging substantially the same region at a predetermined time interval. According to another aspect of the present exemplary embodiment, the image processing apparatus includes an image generation unit configured to generate an MC contrast en face image by using information in part of a depth range of the MC information. According to another aspect of the present exemplary embodiment, the image processing apparatus includes an information acquisition unit configured to obtain information about a change in an MC value of at least part of substantially the same region by using a plurality of MC en face images at different times. Dynamic change information about a blood flow can thereby be provided. The image processing apparatus according to the present exemplary embodiment will be described in detail below with reference to the drawings.

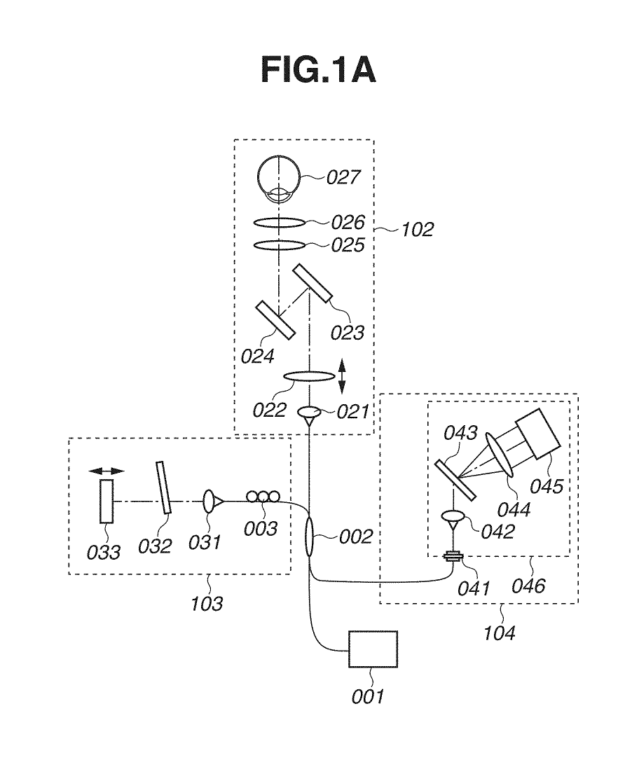

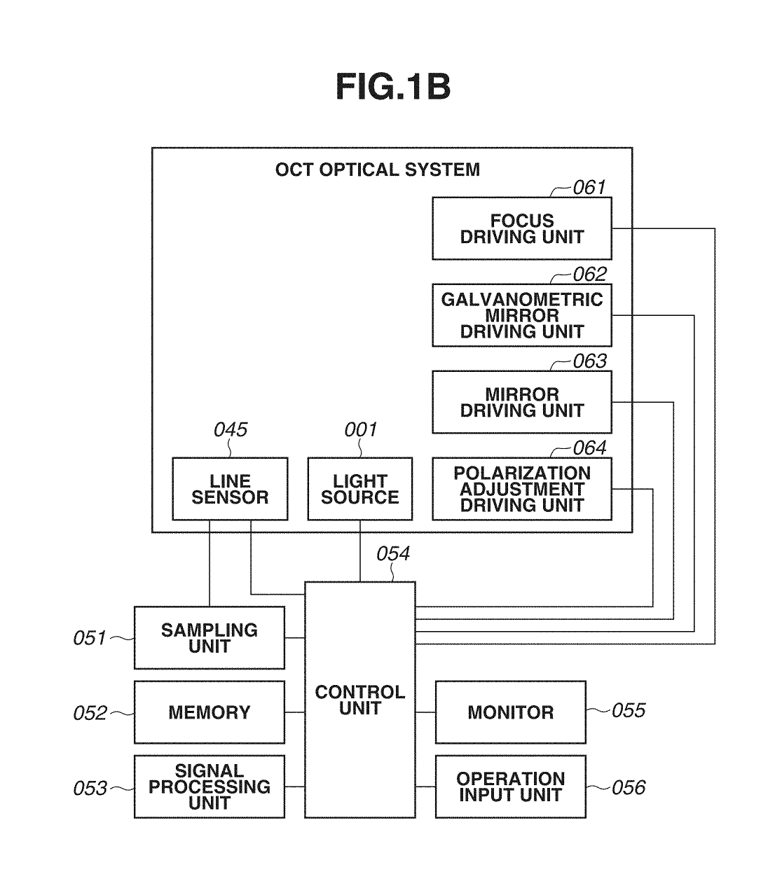

An apparatus configuration for obtaining a plurality of OCTA images will be described with reference to FIGS. 1A and 1B. Next, an overview of a method for obtaining MC value change information according to the present exemplary embodiment will be described, and detailed flows will be successively described.

### [Hardware Configuration: Tomographic Information Acquisition Unit for Obtaining a Plurality of Pieces of Tomographic Information Obtained by Imaging Substantially the Same Region of Eye to be Examined at Predetermined Time Intervals]

In FIG. 1A, a light source 001 is a superluminescent diode (SLD) light source. Light from the light source 001 is branched into measurement light and reference light at a desired branching ratio by a coupler 002. The measurement light is passed through the coupler 002 and emitted to a sample optical system 102 from a collimator 021. The sample optical system 102 includes a focus lens 022, a variable-angle X galvanometric mirror 023 and Y galvanometric mirror 024, and a lens 025 and a lens 026 which form an objective lens system. A beam spot of the measurement light is formed on the fundus of an eye to be examined 027 through such members. The beam spot guided onto the fundus is two-dimensionally scanned over the fundus by driving of the X galvanometric mirror 023 and the Y galvanometric mirror 024. The measurement light reflected and scattered from the fundus of the eye to be examined 027 is passed through the sample optical system 102 and guided to the coupler 002. The reference light is guided to a reference optical system 103, turned into collimated light through a collimator lens 031, and attenuated to a predetermined light amount through a neutral density (ND) filter 032. The reference light is then reflected by a mirror 033 back via the same optical path while being maintained in the collimated state. The mirror 033 can move in an optical axis direction and can correct a difference in optical path length from the sample optical system 102. The returned reference light is passed through the ND filter 032 and the collimator lens 031 and then guided to the coupler 002.

The measurement light and the reference light returned to the coupler 002 are combined by the coupler 002 and guided to a detection system (or spectrometer) 104. The combined light is emitted from a collimator 042, dispersed by a diffraction grating 043, received by a line sensor 045 via a lens 044, and then output as an output signal. The line sensor 045 is arranged so that each pixel receives a corresponding wavelength component of the light dispersed by the diffraction grating 043.

FIG. 1B illustrates an OCT optical system which includes a focus driving unit 061, a galvanometric mirror driving unit 062, a mirror driving unit 063, and a polarization adjustment driving unit 064. The focus driving unit 061 is intended to move the focus lens 022. The galvanometric mirror driving unit 062 is intended to drive the X galvanometric mirror 023 and the Y galvanometric mirror 024. The mirror driving unit 063 is intended to move the mirror 33 in the optical axis direction. The polarization adjustment driving unit 064 is intended to adjust polarization of each light beam. The driving units 061, 062, 063, and 064, the light source 001, the line sensor 045, a sampling unit 051, a memory 052, a signal processing unit 053, an operation input unit 056, and a monitor 055 are connected to a control unit 054, whereby an operation of the entire apparatus (spectral domain optical coherence tomography (SDOCT) apparatus) is controlled. The monitor 055 is an example of a display unit.

The sampling unit 051 outputs the output signal from the line sensor 045 as an interference signal with respect to an arbitrary galvanometric mirror driving position driven by the galvanometric mirror driving unit 062. The galvanometric mirror driving position is then offset by the galvanometric mirror driving unit 062, and an interference signal at that position is output. Such an operation is subsequently repeated to generate interference signals in succession. The interference signals generated by the sampling unit 051 are stored in the memory 052 along with the galvanometric mirror driving positions. The signal processing unit 053 performs frequency analysis on the interference signals stored in the memory 052 to form a tomographic image of the fundus of the eye to be examined 027. The tomographic image is displayed on the monitor 055 by the control unit 054 which is an example of a display control unit. The control unit 054 can generate and display a three-dimensional fundus volume image on the monitor 055 by using galvanometric mirror driving position information.

The control unit 054 obtains background data at arbitrary timing during imaging. The background data refers to a signal in a state where the measurement light is not incident on the subject, i.e., a signal obtained with only the reference light. For example, the galvanometric mirror driving unit 062 drives the galvanometric mirrors 023 and 024 to adjust the position of the measurement light so that the measurement light does not return from the sample optical system 102. In such a state, the control unit 054 performs signal acquisition to obtain background data.

### [Scan Pattern: Scanning the Same Region to Obtain OCTA Image]

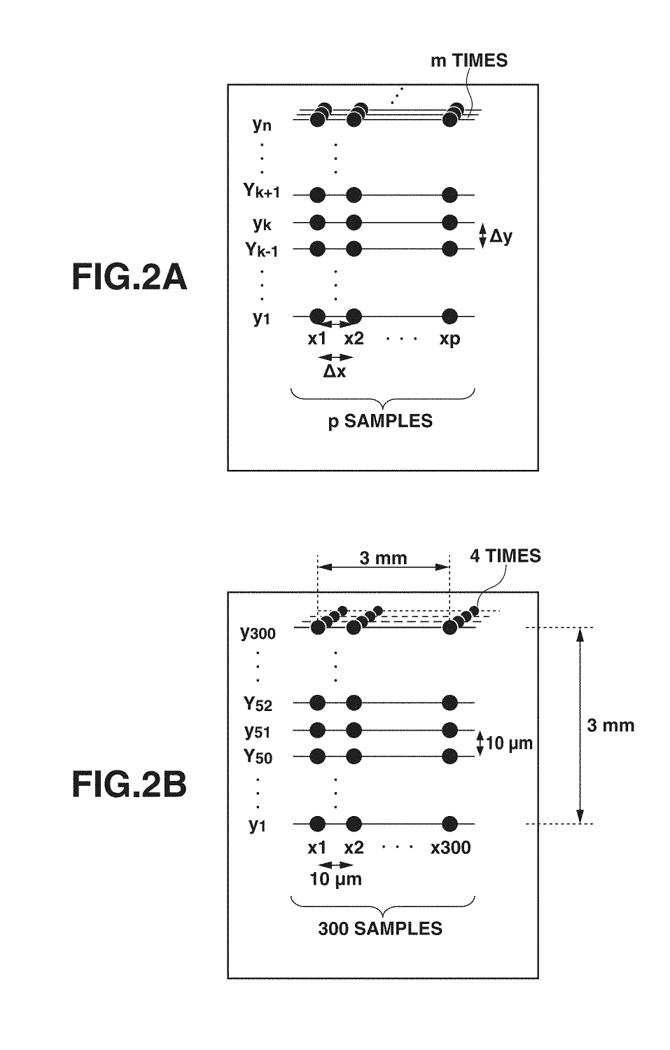

Next, an example of a scan pattern according to the present exemplary embodiment will be described with reference to FIGS. 2A and 2B. FIG. 2A is a diagram illustrating an arbitrary scan. FIG. 2B is a diagram on which specific numerical values used in the present exemplary embodiment are reflected. OCTA needs a plurality of measurements performed at the same position at predetermined time intervals to measure a blood flow-based temporal change in an OCT interference signal. In the present exemplary embodiment, the SDOCT apparatus performs a scan by repeating a B scan at the same position m times while moving the position to n y-positions. FIG. 2A illustrates a specific scan pattern. B scans are repeated m times at n y-positions y₁ to yₙ on the fundus plane. As m increases, the number of measurements at the same position increases and thus the detection accuracy of a blood flow improves. This, however, leads to a prolonged scan time, causing a problem of occurrence of a motion artifact in the image due to eye movement (involuntary eye movement during fixation) during scanning and a problem of increasing burden on the subject. In the present exemplary embodiment, m=4 (FIG. 2B) in consideration of the balance between advantages and disadvantages. The number of repetitions m may be changed according to an A scan speed of the SDOCT apparatus and a motion analysis of a fundus surface image of the eye to be examined 027. The greater a predetermined interval of repetition, the more difficult a fast blood flow is to detect. The smaller the predetermined interval of repetition, the lower the detectability of slow blood flows in capillaries. In the present exemplary embodiment, the predetermined interval is set to approximately 2.5 msec. In the present exemplary embodiment, the predetermined interval may be such that blood flows can be detected. For example, the predetermined interval can be in the range of approximately 1 msec to approximately 4 msec (in some cases, several tens of milliseconds), desirably in the range of approximately 2 msec to approximately 3 msec. Such a repetition interval can also be adjusted according to the blood vessels of interest. In FIG. 2A, p represents the number of A scan samples in one B scan. In other words, a two-dimensional image size is determined by p×n. As p×n increases, a wider range can be scanned at the same measurement pitches. This, however, increases the scan time, causing the foregoing problems of a motion artifact and a burden on the patient. In the present exemplary embodiment, n=p=300 in consideration of the balance between advantages and disadvantages. The n and p can be freely changed as necessary. In FIG. 2A, Δx represents a distance (x pitch) between adjoining x-positions. Δy represents a distance (y pitch) between adjoining y-positions. In the present exemplary embodiment, the x and y pitches Δx and Δy are determined to be ½ the beam spot diameter of the irradiation light on the fundus. In the present exemplary embodiment, the x and y pitches Δx and Δy are 10 μm (FIG. 2B). Setting the x and y pitches Δx and Δy to ½ the beam spot diameter on the fundus enables generation of a high precision image. Making the x and y pitches Δx and Δy smaller than ½ the beam spot diameter on the fundus does not have much effect on improving the precision of the generated image further. On the other hand, making the x and y pitches Δx and Δy greater than ½ the beam spot diameter on the fundus degrades the precision, but enables acquisition of an image of a wider area with a small data capacity. The x and y pitches may be freely changed according to clinical needs. In the present exemplary embodiment, the scan range is p×Δx=3 mm in the x direction and n×Δy=3 mm in the y direction (see FIG. 2B).

### [Flow for Continuous Acquisition of OCTA Images and Generation of MC Value Change Information]

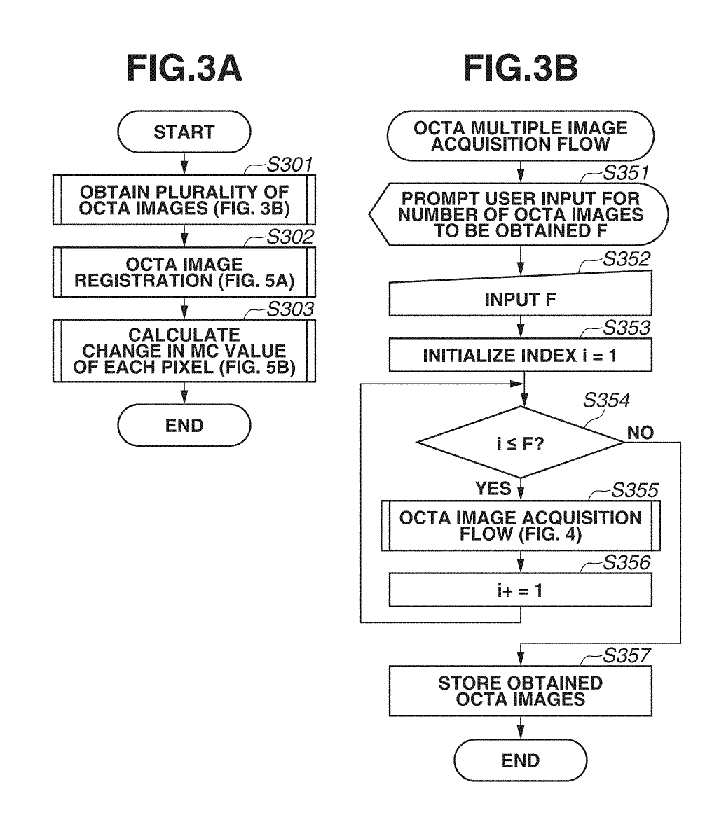

A method for obtaining a plurality of OCTA images (MC images) and obtaining MC value change information (information about a change in the MC value) about each individual pixel of each OCTA image by using the foregoing SDOCT apparatus will be outlined with reference to FIGS. 3A and 3B. To obtain a plurality of OCTA images, the acquisition of data needed to generate a single OCTA image is repeated. Step S301 corresponds to such a step. FIG. 3B illustrated details thereof. In step S351, the control unit 054 displays a graphical user interface (GUI) for prompting a user input for the number of OCTA images to be obtained F on the monitor 055. In step S352, the user inputs the number of OCTA images to be obtained F (F: an integer of 2 or more). In step S353, the control unit 054 initializes an index i, which indicates the number of OCTA images obtained, to 1. The control unit 054 subsequently counts up the index i after an output signal for generating a single OCTA image is obtained by controlling the OCT optical system. As illustrated in steps S354, S355, and S356, the acquisition of an OCTA image or data needed for image generation is repeated until the index i reaches the number of OCTA images to be obtained F specified by the user. If data needed for image generation is thus obtained instead of already-generated images, the desired number of OCTA images needs to be generated from the data. This is not necessarily the case if already-generated OCTA images are obtained, for example, from an external database. A detailed procedure for generating an OCTA image will be described below with reference to an OCTA image acquisition flow. In the present exemplary embodiment, the control unit 054 obtains ten OCTA images. In step S357, the control unit 054 stores the obtained OCTA images. After the acquisition of the needed number of OCTA images in step S301, the processing proceeds to step S302. In step S302, the signal processing unit 053 performs registration between the plurality of OCTA images (see an OCTA image registration flow to be described below). In step S303, a change information calculation unit (information acquisition unit) in the signal processing unit 053 finally calculates a change in the MC value at each pixel position (see an MC value change acquisition flow to be described below). For image registration, not the OCTA images themselves intended to calculate changes in the MC values but fundus en face OCTA images generated from a predetermined depth portion of intensity images used in generating the OCTA images may be used instead. In selecting the predetermined depth portion, a surface layer portion well expressing retinal major blood vessels may be designated. Fundus projection en face images covering the entire depth range, well expressing features of the entire retina, can often be used for accurate registration.

### [Acquisition of OCTA Image]

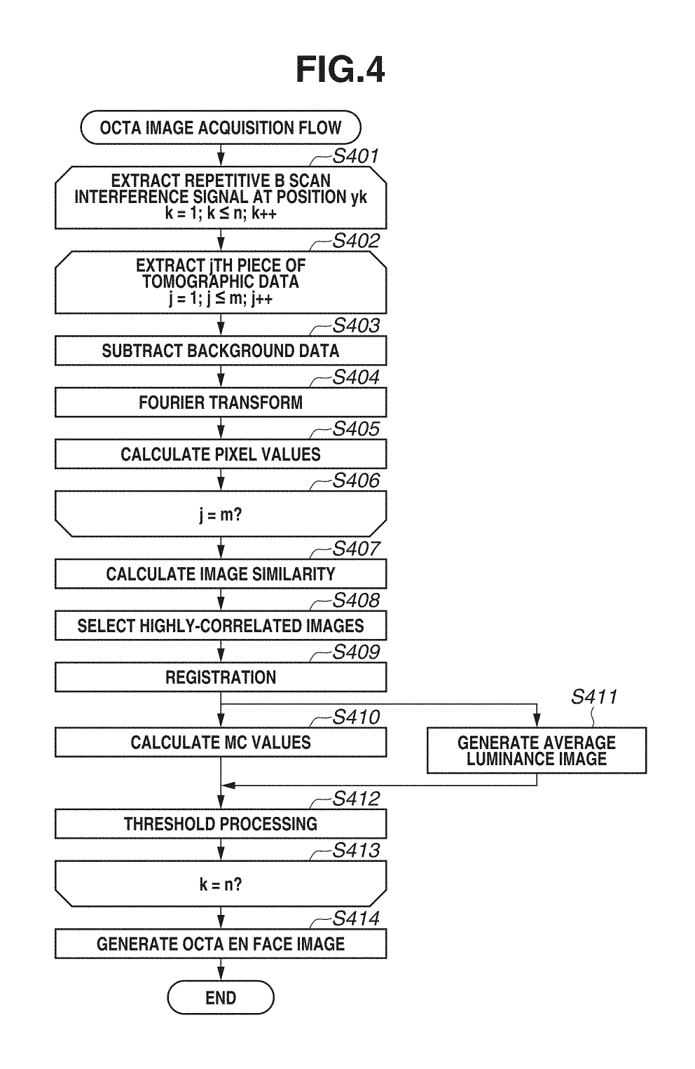

Next, a method for generating an OCTA image (MC image) from a single data set obtained by the foregoing flow will be described with reference to FIG. 4. The signal processing unit 053 which is an example of the information generation unit generates MC information about substantially the same region of the eye to be examined 027 by using a plurality of pieces of tomographic information obtained by imaging substantially the same region at predetermined time intervals. The signal processing unit 053 which is an example of the image generation unit then generates an MC en face image by using information in part of a depth range of the MC information.

In step S401, the signal processing unit 053 extracts a repetitive B scan interference signal (m frames) at position yₖ. In step S402, the signal processing unit 053 extracts a jth piece of tomographic data (information). In step S403, the signal processing unit 053 subtracts obtained background data from the foregoing interference signal. In step S404, the signal processing unit 053 applies wave function conversion processing to the interference signal from which the background data is subtracted, and applies a Fourier transform. In the present exemplary embodiment, the signal processing unit 053 applies a fast Fourier transform (FFT). Zero padding processing can be applied in advance to enhance the gradation after the Fourier transform and improve the registration accuracy in step S409. In step S405, the signal processing unit 053 calculates the absolute values of complex signals obtained by the Fourier transform performed in step S404. The absolute values serve as the pixel values (luminance values) of the tomographic image at this scan. In step S406, the signal processing unit 053 determines whether the index j has reached a predetermined number (m). In other words, the signal processing unit 053 determines whether the luminance calculation of the tomographic image at position yₖ is repeated m times. If the index j has not reached the predetermined number, the processing returns to step S402 and the signal processing unit 053 repeats the luminance calculation of the tomographic image at the same y-position. If the index j has reached the predetermined number, the processing proceeds to step S407.

In step S407, the signal processing unit 053 calculates an image similarity among the m frames of similar tomographic images at position yₖ. Specifically, the signal processing unit 053 selects any one of the m frames of tomographic images as a template, and calculates correlation values with the remaining (m−1) frames of tomographic images. In step S408, the signal processing unit 053 selects highly-correlated images of which the correlation values calculated in step S407 are greater than or equal to a certain threshold. The threshold can be arbitrarily set. The threshold is set so that a frame or frames of low image correlation due to the subject's blinking or involuntary eye movement during fixation can be excluded. As described above, OCTA is a technique for distinguishing contrast between flowing tissue (such as blood) and flowless tissue among the subject's tissues based on local correlation values between images. In other words, flowing tissue is extracted on the assumption that flowless tissue shows high correlation between images. If images have low correlation as a whole, the entire images can be misidentified as those of flowing tissue. In this step, to avoid such misidentification, tomographic images of low image correlation are excluded in advance to select only highly correlated images. As a result of the image selection, the m frames of images obtained at the same position yₖ are sorted out as appropriate to select q frames of images. The possible range of q is 1≤q≤m.

In step S409, the signal processing unit 053 performs registration of the q frames of tomographic images selected in step S408. To select the frame serving as a template, correlation may be calculated between all possible combinations of the frames. Then, the sum of the correlation coefficients may be determined frame by frame, and the frame having the maximum sum may be selected as the template. Next, each frame is collated with the template to determine a position shift amount (δx, δy, δθ). Specifically, normalized cross-correlation (NCC), which is an index indicating similarity, is determined while changing the position and angle of the template. A difference in image position when NCC becomes maximum is determined as the position shift amount. In the present exemplary embodiment, various indexes indicating similarity may be used as long as the indexes indicate the similarity of features between the template and the image in the frame. For example, a sum of absolute difference (SAD), sum of squared difference (SSD), zero-means normalized cross-correlation (ZNCC), phase only correlation (POC), and rotation invariant phase only correlation (RIPOC) may be used.

Next, the signal processing unit 053 applies position correction to the (q−1) frames other than the template according to the position shift amount (δx, δy, δθ), whereby frame registration is performed. This step is skipped if q=1.

In step S410, the signal processing unit 053 calculates MC values. In the present exemplary embodiment, the signal processing unit 053 calculates variance values for each pixel at the same position in the q frames of luminance images that are selected in step S408 and registered in step S409, and uses the variance values as the MC values. MC values can be determined by various methods. In the present exemplary embodiment, any index that indicates a change in each pixel (such as luminance or phase after Fourier transform) of the plurality of tomographic images at the same y-position may be applied as an MC value. If q=1, i.e., image correlation is so low due to blinking or involuntary eye movement during fixation that MC values at the same position yₖ are unable to be calculated, different processing is performed. For example, the step may be ended with MC values of 0. If MC values can be obtained from the images at the previous and next positions yₖ₋₁ and yₖ₊₁, MC values may be interpolated from those at the previous and next positions yₖ₋₁ and yₖ₊₁. In such a case, an abnormality notification may be made indicating that MC values unable to be properly calculated are interpolated. The y-position at which the MC values failed to be calculated may be stored and automatically re-scanned. A warning for prompting remeasurement may be issued instead of automatic re-scanning.

In step S411, the signal processing unit 053 averages the luminance images registered in step S409 to generate an average luminance image.

In step S412, the signal processing unit 053 performs threshold processing on the MC values output in step S410. The threshold is set to an average MC value of the noise floor+2σ. σ is a standard deviation calculated by extracting areas of the noise floor where only random noise is displayed in the average luminance image output by the signal processing unit 053 in step S411. The signal processing unit 053 sets to 0 the MC values corresponding to areas where the luminance value is lower than or equal to the threshold. By such threshold processing, MC values derived from random noise can be removed for noise reduction. The lower the threshold, the higher the detection sensitivity of the MC values, but the noise components increase at the same time. The higher the threshold, the less the noise but the lower the detection sensitivity of the MC values. In the present exemplary embodiment, the threshold is set to the average MC value of the noise floor+2σ, but the threshold is not limited thereto.

In step S413, the signal processing unit 053 determines whether the index k has reached a predetermined number (n). In other words, the signal processing unit 053 determines whether the calculation of image similarity, image selection, registration, the calculation of average luminance, the calculation of MC values, and the threshold processing has been performed on all the n y-positions. If the index k has not reached the predetermined number, the processing returns to step S401. If the index k has reached the predetermined number, the processing proceeds to the next step S414. When step S413 ends, there is generated MC value three-dimensional volume data which is a set of an average luminance image of the tomographic images at all the y-positions and a plurality of adjacent pieces of MC information at n y-positions. In step S414, the signal processing unit 053 generates an MC en face image (hereinafter, referred to as an OCTA en face image) by integrating the generated three-dimensional MC values (MC information) in a depth direction. In generating the OCTA en face image, the depth range of integration may be arbitrarily set. For example, layer boundaries of the fundus retina can be extracted based on the average luminance image generated in step S411, and an OCTA en face image can be generated to include a desired layer. After the generation of the OCTA en face image, the signal processing unit 053 ends the signal processing flow. By using the apparatus configuration, imaging method, and signal processing procedure described above, OCTA imaging and the generation of OCTA images can be performed in a desired area. In the present exemplary embodiment, OCTA images (MC images) can be obtained under the condition of m=4.

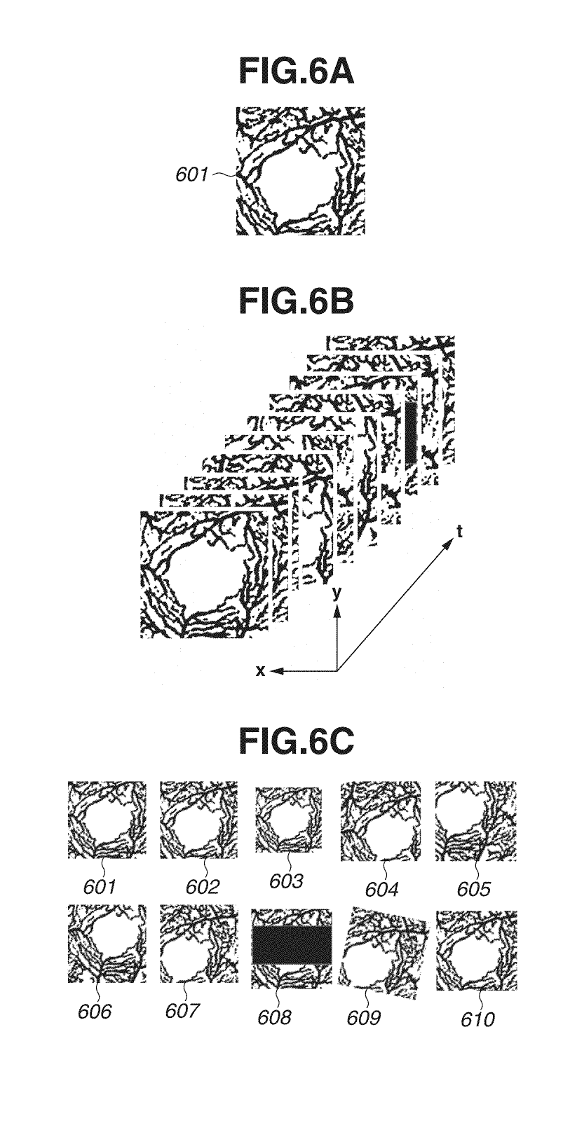

FIGS. 6A to 6C illustrate examples of obtained OCTA images. For example, suppose that the depth range of integration of the three-dimensional MC information obtained by imaging a macular portion is limited to several layers on the surface layer side of the retina. In such a case, an OCTA en face image of the retinal surface layer illustrated in FIG. 6A can be obtained, in which fundus vessels around the macula are extracted. It will be understood that the intended depth range of the present exemplary embodiment is not limited to the surface layers of the retina, and blood vessels in retinal deep layers and the choroid can be extracted from an OCTA en face image in which the depth range is set to such layers.

### [Registration of OCTA Images]

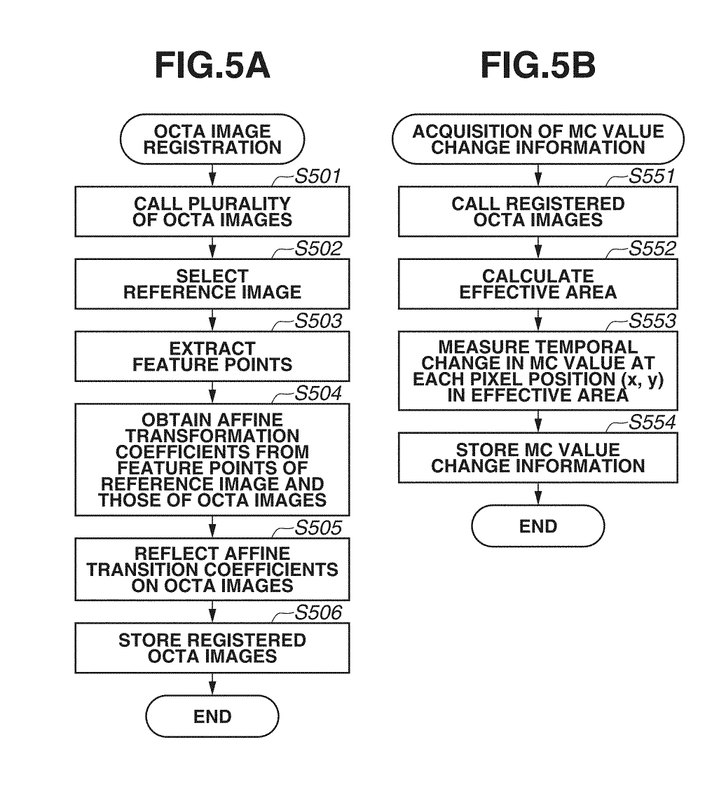

A method for registering a plurality of OCTA images will be described with reference to FIG. 5A.

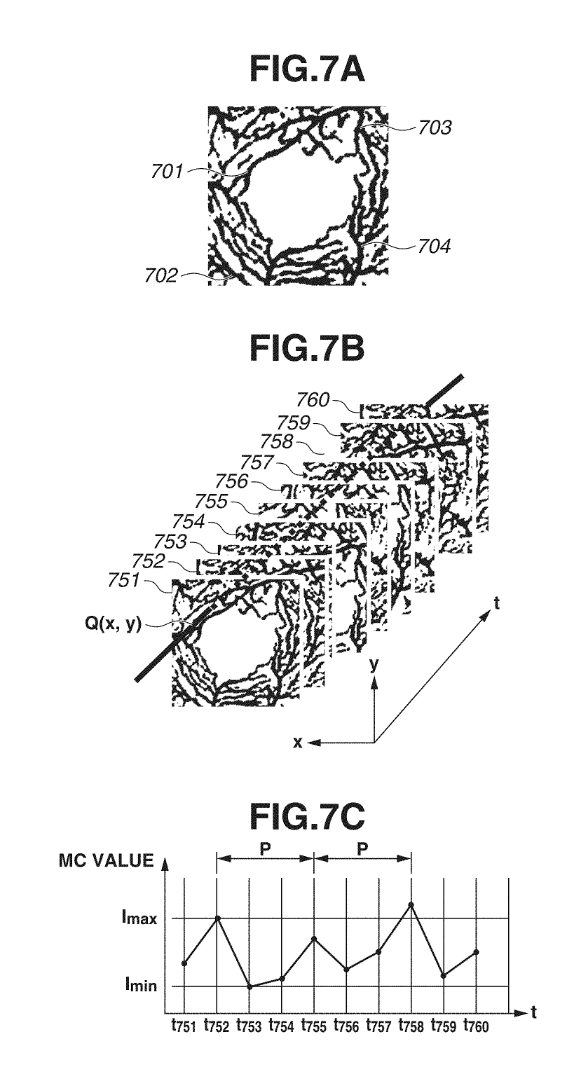

In step S501, the signal processing unit 053 calls a stored plurality of OCTA images (FIG. 6B) obtained in time series. In step S502, the signal processing unit 053 extracts a reference image from among the plurality of OCTA images (601 to 610 in FIG. 6C). Various methods can be used to extract a reference image. Examples may include comparing the OCTA images with a fundus image obtained by another device (such as a scanning laser ophthalmoscope (SLO) and a fundus camera) and selecting an OCTA image having a high correlation function (high matching rate), and analyzing and selecting image information for extracting an OCTA image in which blood vessels have a high rate of connection. If the SDOCT apparatus has an eye movement detection function, an OCTA image captured with least involuntary eye movement during fixation in obtaining the OCTA images may be selected as the reference image. In the present exemplary embodiment, for example, the OCTA image 601 in FIG. 6C is selected by using a method for comparing the OCTA images with a fundus image obtained by an SLO which is a fundus observation system provided beside the SDOCT apparatus. In step S503, the signal processing unit 053 extracts four intersections of blood vessels (701 to 704) illustrated in FIG. 7A as feature points in the reference image 601. Any method for extracting feature points may be used as long as feature points having less similarities to other areas can be extracted. Examples may include extracting high MC value areas, and extracting singularities resulting from two-dimensional frequency conversion. The methods can be changed or combined depending on the measurement region. The signal processing unit 053 then extracts, from the OCTA images 602 to 610, feature points corresponding to the feature points extracted in the reference image 601. In step S504, the signal processing unit 053 obtains affine transformation coefficients (x, y, and z shift amounts, rotation, and scaling if needed) between the reference image 601 and the OCTA images 602 to 610 by using the feature points of the reference image 601 and those of the OCTA images 602 to 610 extracted in step S503. In step S505, the signal processing unit 053 reflects the obtained affine transformation coefficients on the respective OCTA images 602 to 610 to register the OCTA images 602 to 610 with respect to the reference image 601. In step S506, the signal processing unit 053 stores the resulting registered OCTA images into the memory 052. In the present exemplary embodiment, OCTA images that include a large missing area due to abrupt eye movement or blinking of the eye to be examined 027 and are incapable of extraction of feature points needed, like the OCTA image 608 of FIG. 6C, are not used in the subsequent processing.

### [Acquisition of MC Value Change Information by Using a Plurality of OCTA Images at Different Times]

Next, a method for obtaining MC value change information (data) from a plurality of OCTA images will be described with reference to FIG. 5B. The signal processing unit 053 which is an example of the information acquisition unit obtains information about a change in the MC values of at least part of substantially the same region by using a plurality of OCTA images (MC en face images) at different times. In the present exemplary embodiment, the time interval (within a predetermined time) of data acquisition of a plurality of OCTA en face images is approximately 1 sec. In the present exemplary embodiment, the time interval (within a predetermined time) may be arbitrarily set as long as information about a change can be obtained. For example, the time interval (within a predetermined time) can be approximately 0.1 sec to approximately 5 sec. If n OCTA en face images are obtained at intervals of 1 sec, the MC value change information has an observation time range of n×1 sec, and substantially includes information about n pulsations. The observation range is determined in consideration of observation stability and a total imaging time, i.e., a burden on the subject. While the imaging intervals here are substantially constant, this is not restrictive. MC value change information needed can be observed if an observation time for several pulsations is secured. Further contrivances may be needed to further obtain detailed MC value change information associated with pulsations.

In step S551, the signal processing unit 053 calls a stored plurality of registered OCTA images 751 to 760 in FIG. 7B. In step S552, the signal processing unit 053 calculates a common image area (effective area) from the plurality of OCTA images 751 to 760 called. The reason is that the OCTA images do not always include image edges of a fundus region because of slight deviations of the fundus region captured in the respective OCTA images due to eye movement. FIG. 7C illustrates the MC values of a pixel at coordinates (x1, y1) in the effective area of the respective OCTA images 751 to 760, plotted in step S553 with respect to times t₇₅₁ to t₇₆₀ at which the OCTA images 751 to 760 have been obtained. In the present exemplary embodiment, the times t₇₅₁ to t₇₆₀ at which the OCTA images 751 to 760 have been obtained are at substantially constant intervals. In step S554, the MC value change information is stored in the memory 052.

A method for obtaining a plurality of OCTA images and obtaining MC value change (blood change) information of the OCTA images has been described above.

A change in the MC value may be calculated not by the foregoing pixel-to-pixel processing but after weighted spatial addition of approximately 5×5 pixels. This can reduce artifacts due to noise and registration errors.

### (MC Value Change Information)

In a first exemplary embodiment, an example of quantitative analysis of an MC value profile obtained in the foregoing exemplary embodiment will be described.

With respect to changes in the MC value of a predetermined pixel illustrated in FIG. 7C, the signal processing unit 053 calculates statistics such as a maximum MC value (Iₘₐₓ), a minimum MC value (Iₘᵢₙ), an average MC value (Iₐᵥₑ), a standard deviation (I_{σ}) of the MC value, an MC value maximum variation width (∥Iₘₐₓ−Iₘᵢₙ|), a basic period of change (P), and a phase. In other words, information about a change in the MC value is information about, for example, at least one of the amplitude, period, and phase of the change in the MC value. The control unit 054 which is an example of the display control unit displays the results as an image and statistics on the monitor 055. The basic period (P) can be calculated by a Fourier transform and the like. In the present exemplary embodiment, peaks are calculated to occur when each of the four OCTA images are obtained. In terms of actual imaging times, the basic period P is found to be approximately 45 seconds.

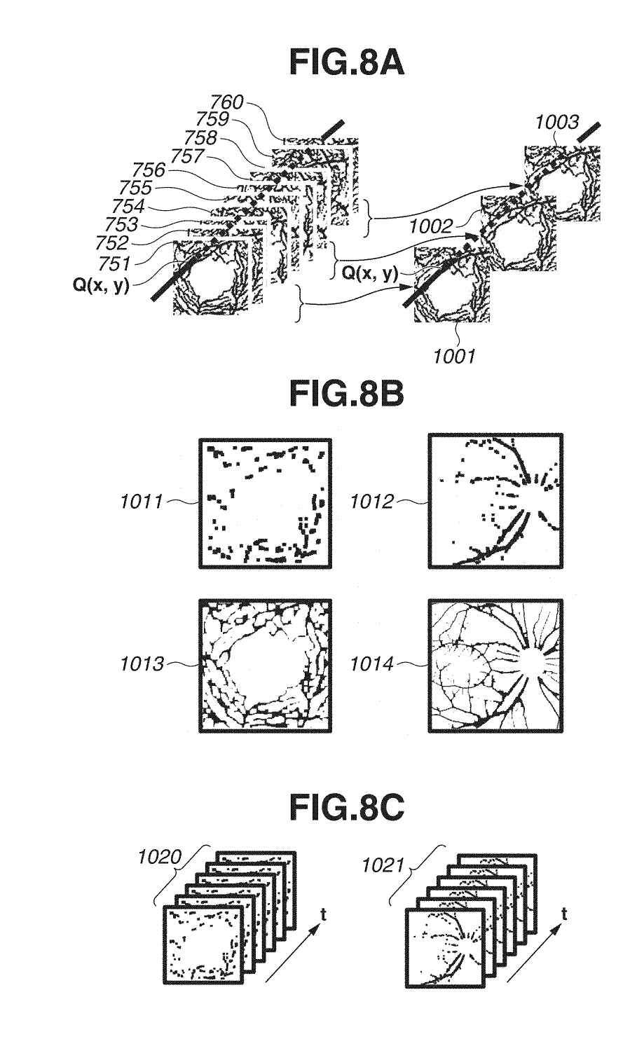

The MC value change information can be drawn as an image by performing the foregoing analysis on all the pixels within the coordinates of the effective area of each OCTA image. As an example, FIG. 8B illustrates an image 1011 which is generated for a macula portion with the MC value maximum variation width (|Iₘₐₓ−Iₘᵢₙ|), and an image 1012 which is generated for an optic disc portion. Note that such images (MC value variation width maps) 1011 and 1012 are discrete dot images.

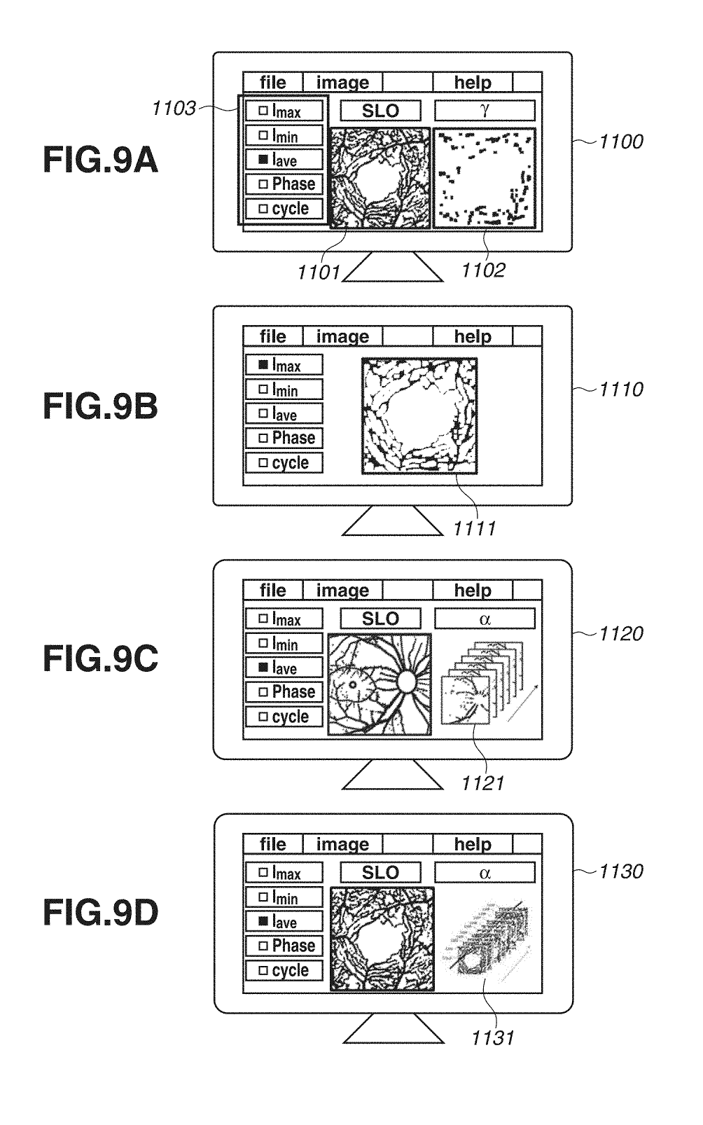

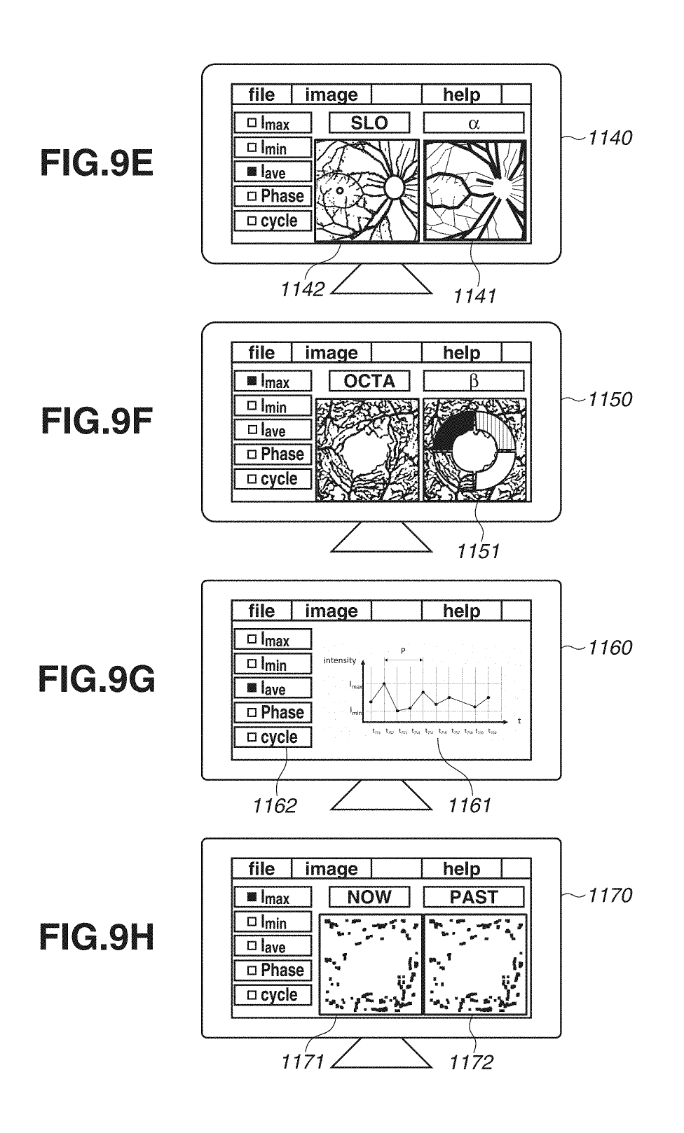

FIGS. 9A to 9H illustrate examples of actual display mode. A monitor 1100, which is a display, displays a screen showing analyses of the fundus of a macular portion area (3 mm×3 mm) by the procedure of the present exemplary embodiment. As described above, there are various possible patterns of parameters expressing a temporal change in the MC values. Display areas 1101 and 1102 then can be switched to display various images. For example, in FIG. 9A, the display area 1101 displays an image 1013 of FIG. 8B which is formed by imaging the macular portion with the maximum values Iₘₐₓ of the MC values in the OCTA images. Next to the display area 1101, the display area 1102 displays the image 1011 of FIG. 8B which is formed by imaging (rendering as an MC value variation width map) the MC value variation widths (|Iₘₐₓ−Iₘᵢₙ|). As described above, the MC value variation width map 1011 is a discrete dot image. It is difficult to determine which part of the fundus the region under observation is if the MC value variation width map 1011 is displayed alone. An image well depicting the whole blood vessels, like the image of the maximum values Iₘₐₓ of the pixels, is therefore desirably displayed aside. For the purpose of identifying the region under observation, an OCTA image 601, an SLO image, or a fundus photograph can also be effectively displayed aside. A plurality of MC value variation width maps 1011 may be obtained during examinations on the same day, and an image 1013 (macula) generated by adding the plurality of MC value variation width maps 1011 may be displayed.

### (Modification)

A moving image-based observation of a change in the MC values provides important diagnostic information. For example, as illustrated in FIG. 9D, the right display area 1102 may switch and continuously (successively) display OCTA images 1131 in a moving image manner. Up to this point, examples of displaying two types of images in the display areas 1101 and 1102 side by side have been described. However, a method of benefiting from the effects of the present exemplary embodiment is not limited thereto. For example, as illustrated in FIG. 9B, a color image in which the maximum values Iₘₐₓ of the MC values are assigned to luminance information of the respective pixels and the MC value variation widths (|Iₘₐₓ−Iₘᵢₙ|), i.e., MC value change information is assigned to hue can be displayed in a display area. Here, which MC value change information is selected can be switched by using selection buttons 1110 provided in a selection area on the right of the display screen. The values to be assigned to the luminance information are not limited to the maximum values Iₘₐₓ of the MC values, and pixel values of an OCT intensity image or an OCTA image may be assigned. FIGS. 9E to 9H illustrate variations of the display mode, which will be described as appropriate in other exemplary embodiments.

### (Display of Changes in MC Values by Region)

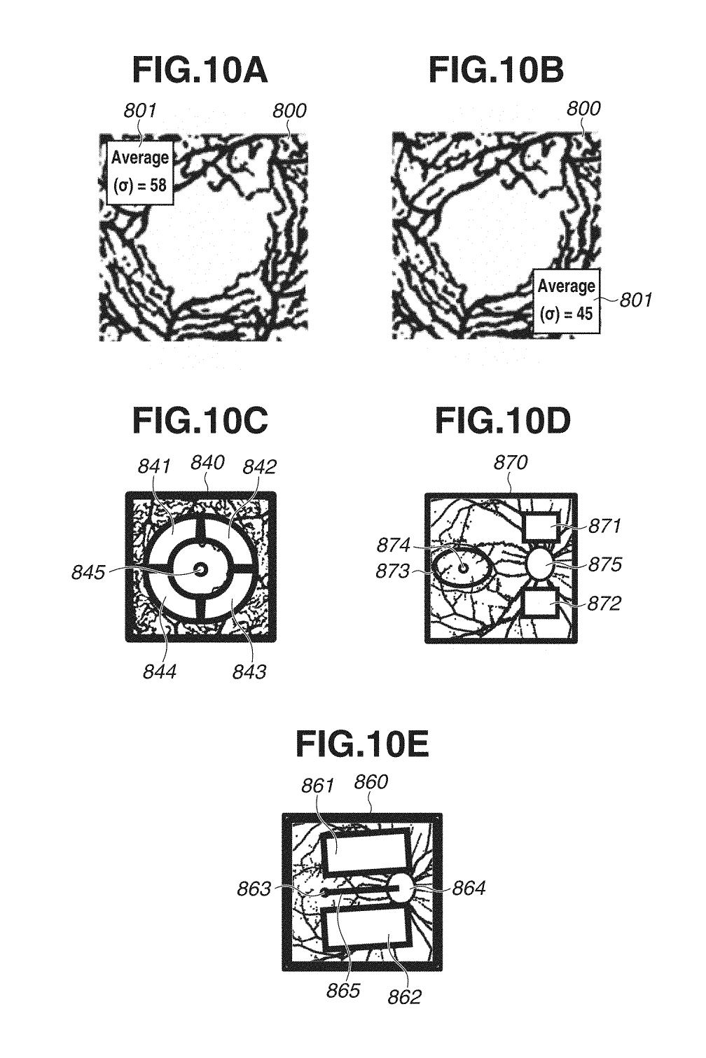

In the foregoing exemplary embodiments, an example of calculating, imaging, and displaying MC value change information from OCTA images has been described. In a second exemplary embodiment, an operator can set a region of interest (ROI) 801 on an image 800 as illustrated in FIG. 10A by using a not-illustrated pointing device such as a mouse. Statistics (for example, an average) of the MC value change information in the ROI 801 are then displayed. For example, a signal processing unit 053 which is an example of an average image generation unit generates an average image of a plurality of MC en face images. The image 800 is a color image in which the maximum values Iₘₐₓ of MC values described in FIG. 9B are assigned to luminance information of respective pixels, and standard deviations (I_{σ}) of the MC values of the respective pixels, which are MC value change information, are assigned to hue. The signal processing unit 053 calculates an average value of the MC value change information in the ROI 801, displays the average value on the monitor 055 in the form of a numerical value, like Average(σ)=58, and changes the hue inside the ROI 801 according to the average value. Such a presentation method enables general representation of the MC value change information in the ROI 801, so that the tendency of changes in the MC values can be easily understood region by region. To check the tendency in other regions, the operator can move the ROI 801 as illustrated in FIG. 10B by using the not-illustrated pointing device such as a mouse.

As a modification of the present exemplary embodiment, as illustrated in FIGS. 10C and 10D, a plurality of ROIs may be set according to respective pieces of patient information so that average MC value change amounts displayed can be compared with each other. At least one of a plurality of concentric circular areas, a plurality of sector areas, and a plurality of arcuate areas substantially about an optic disc or macula is desirably automatically set as an ROI. More specifically, a dividing line, in a center direction, of at least one of a plurality of concentric circular areas, a plurality of sector areas, and a plurality of arcuate areas is desirably automatically determined for an ROI. For example, in the case of a macular portion, the center and average diameter of a foveal avascular area are determined by analysis of OCTA images, and concentric circular four-way split ROIs (plurality of regions) about the center are set as illustrated in FIG. 10C. Such an approach is effective for many macular diseases. The application of similar ROIs to the center of the optic disc is also effective in comprehending a state of circulation of the entire retina and in diagnosing glaucoma. Here, upper and lower two-way split ROIs can be set for more general comprehension. As a more simple approach, as illustrated in FIG. 10D, two rectangular ROIs 871 and 872 may be set above and below an optic disc portion 875. As illustrated in FIG. 10E, ROIs 861 and 862 may be symmetrically set with respect to a line 865 that connects a macular center portion 863 and an optic disc center portion 864. Such an approach is effective in diagnosing age-related macular degeneration. In this example, the rectangular ROIs 861 and 862 are set at equal distances from the line 865, whereas two ROIs in contact with the line 865 may be set to use the line 865 as the dividing line of the ROIs. In the present exemplary embodiment, the ROI setting procedure is described so that ROIs are defined in the OCT system disease by disease and are set automatically. However, an approach that allows the operator to set and register ROIs by himself/herself as illustrated in FIG. 10A is also effective. It will be understood that the shapes and number of such ROIs can be arbitrarily set. The plane of the MC en face image can be divided with a line connecting the optic disc portion and macular portion of the eye to be examined 027 as a dividing line.

As described in FIG. 10A, the method for displaying the average value of the MC value change information in the diagram includes assigning the MC value change information to the hue of color pixels. For example, in FIG. 10A, a region 851 with large changes in the MC values is illustrated in black. A region 852 in which changes in the MC values are large but smaller than in the black region is illustrated with vertical lines. A region 853 with small changes in the MC values is illustrated with lattices. A region 854 with hardly any changes in the MC values is illustrated in white. Such representation should be understood as an approximation of different hues assigned to the regions.

### (MC Value Change Information Along Blood Vessels)

A third exemplary embodiment deals with a case where an MC value profile is mapped along blood vessels in an OCTA image to display changes in the MC values of the blood vessels.

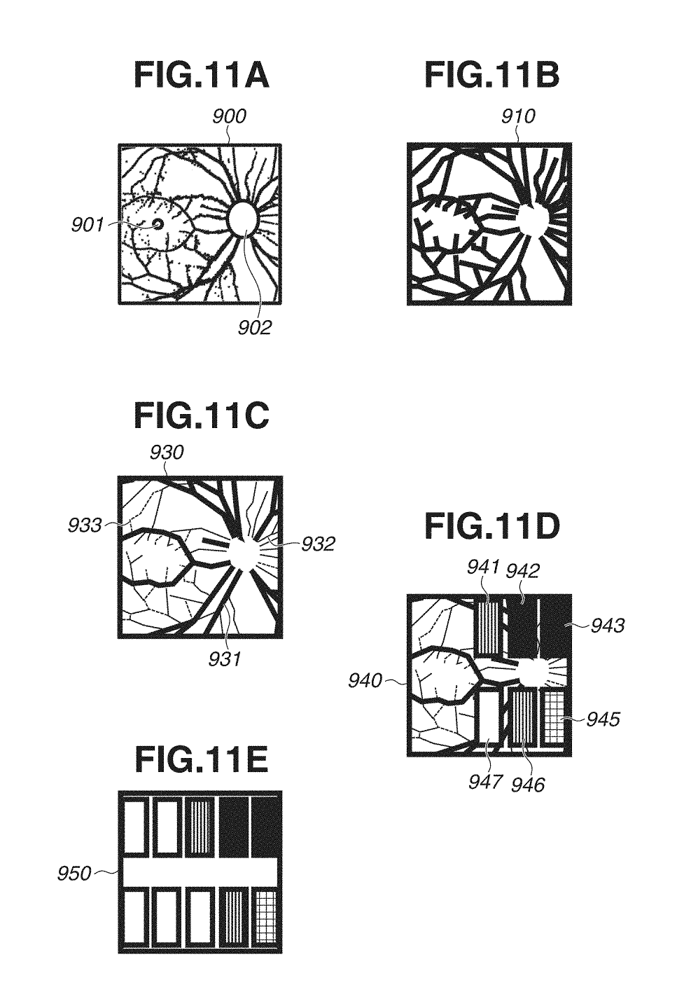

As illustrated in FIG. 11A, a signal processing unit 053 obtains an OCTA image 900 of a range (12×12 mm) in which a macular portion 901 and an optic disc portion 902 can be simultaneously captured. The macular portion 901 is an avascular area and usually is not depicted by OCTA, whereas in this diagram the macular portion 901 is schematically represented by a circle. Any fundus image including blood vessels, such as an SLO image and a fundus camera image, may be used instead of an OCTA image. Next, the signal processing unit 053 obtains an image of FIG. 11B, which is a blood vessel map, by binarizing and rendering in thin lines the obtained OCTA image 900. The signal processing unit 053 further applies processing similar to that of the first exemplary embodiment to the blood vessels mapped in thin lines, thereby reflecting changes in the MC values on the line widths of the target blood vessels. More specifically, the signal processing unit 053 generates an image 930 of FIG. 11C on which blood vessels having thicknesses corresponding to changes in the MC values are mapped. Here, blood vessels with large changes in the MC values are displayed by thick lines 931, blood vessels with small changes in the MC values by medium lines 932, and blood vessels with hardly any changes in the MC values by thin lines 933. This enables the examiner to figure out not only the presence of the blood vessels but the amounts of change in the MC values at the same time. Now, a modification of display similar to that of the second exemplary embodiment will be described with reference to FIG. 11D. FIG. 11D illustrates set ROI areas 941 to 943 and 945 to 947 which are mapped in black, with vertical lines, with lattices, and in white in descending order of changes in the MC values. In this modification, unlike the second exemplary embodiment, the MC value change information is not provided based on a numerical value averaged over all pixels. Instead, changes in the MC values of only the pixels on the blood vessels are quantified in numbers, and the total amounts of changes are mapped as MC value change values. In the present modification, the MC value change information is expressed by black, vertical lines, lattices, and white. It will be understood that, like the second exemplary embodiment, the display may be provided by assigning the blood vessel map to luminance and assigning the MC value change information to hue.

The amounts of change in the MC values of blood vessels are associated with fundus diseases and thus can serve as diagnostic assistance information. Displaying the image 930 obtained in the present exemplary embodiment and an SLO image side by side in parallel facilitates understanding of fundus position information (positional relationship with a disease region) (FIG. 9E). The image to be displayed aside may be a fundus image or other eye information instead of an SLO image 1142.

### (Improvement of Accuracy by Using Composite OCTA Images)

In the foregoing exemplary embodiments, as described in FIGS. 7A to 7C, MC value change information is generated based on MC values in each of a plurality of OCTA images. However, a plurality of OCTA images may be composited before similar processing is applied to generate MC value change information. A fourth exemplary embodiment will be described with reference to FIGS. 8A to 8C. In FIG. 8A, three OCTA images 751 to 753 are composited (subjected to average processing) to obtain a composite OCTA image 1001. Similarly, a composite OCTA image 1002 is obtained from three OCTA images 754 to 756, and a composite OCTA image 1003 is obtained from three OCTA images 757 to 759 (an OCTA image 760 is unused due to processing reasons). MC value change information at each pixel position is obtained by using the resulting composite OCTA images 1001 to 1003. In the present exemplary embodiment, temporally-gentler MC value change information is obtained by applying a low-pass filter to the temporal frequency by the use of composite OCTA images. The number of OCTA images to be averaged and the use of a moving average may be adjusted according to the degree of temporal change in question.

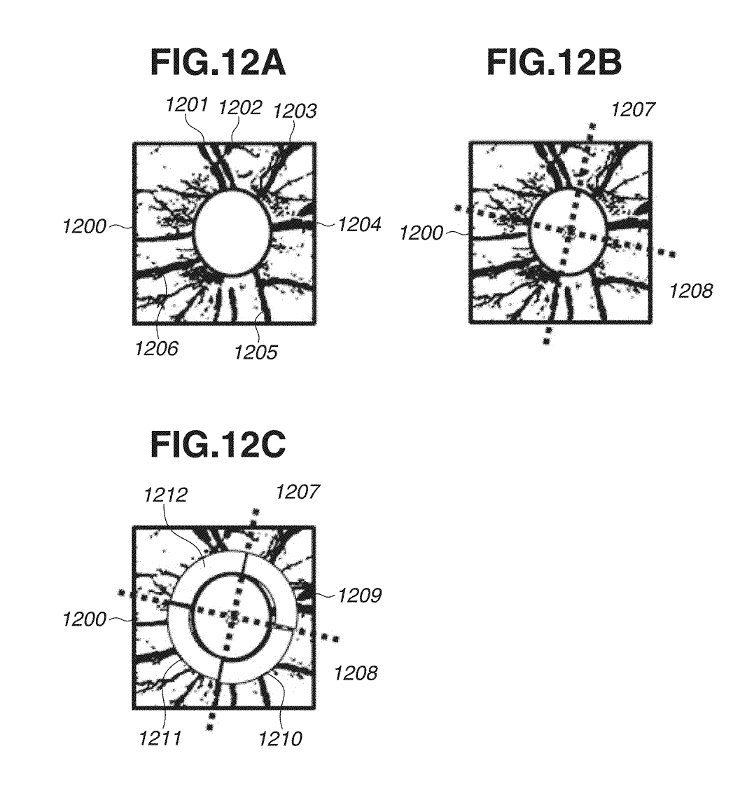

A plurality of concentric circular, sector, and/or arcuate areas substantially about an optic disc, described in the modification of the second exemplary embodiment, may be automatically set by using the foregoing thin-lined blood vessel map. More specifically, FIG. 12A illustrates a fundus image (an SLO image or a fundus photograph may be used as a fundus two-dimensional (2D) image) captured about an optic disc 1200 on the fundus, in which a plurality of blood vessels 1201 to 1206 having large vascular diameters are observed around the optic disc. Dividing lines illustrated in FIG. 12B are determined in consideration of the number of blood vessels having large vascular diameters. In the present exemplary embodiment, dividing lines 1207 and 1208 for dividing concentric circular ROIs in four are determined with reference to the optic disc so that similar numbers (predetermined numbers) of blood vessels having large vascular diameters are included as much as possible. ROIs 1209 to 1212 are thereby determined. More specifically, a signal processing unit 053 which is an example of a blood vessel specification unit specifies a predetermined number of blood vessels having large vascular diameters among blood vessels around the optic disc of the eye to be examined. The signal processing unit 053 which is an example of an average processing unit then determines a dividing line, in a center direction, of at least one of a plurality of concentric circular, sector, and arcuate areas based on the output of the blood vessel specification unit. The average processing unit here performs average processing on the plane of an MC en face image. It will be understood that the examiner may manually select the ROI division.

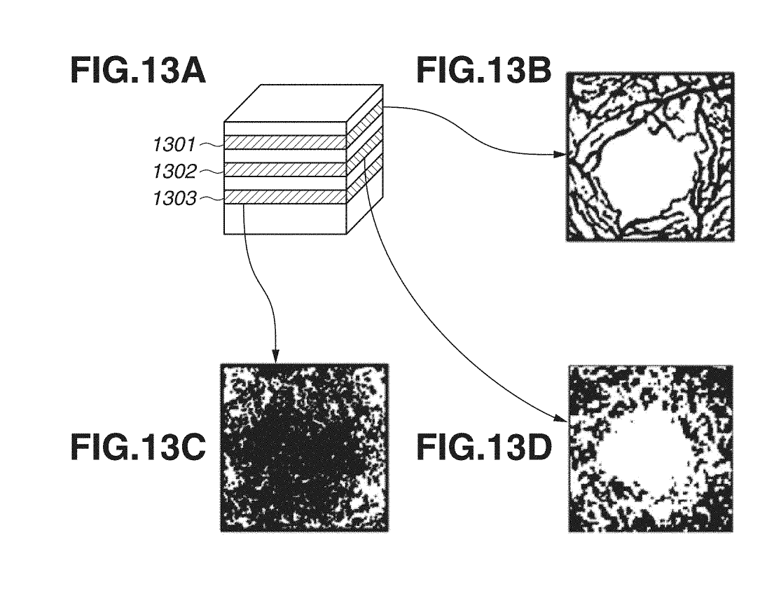

In the first to fourth exemplary embodiments, an OCTA en face image of a surface layer portion (1301 in FIG. 13A) of the retina is obtained. Since three-dimensional MC information is obtained as OCTA images, OCTA en face images can also be obtained from layers other than the surface layer portion. For example, in a fifth exemplary embodiment, OCTA en face images 13D and 13C can be obtained from a retinal deep layer 1302 and a choroid layer 1303. It will be understood that MC value change information can be similarly obtained from the MC values of such OCTA en face images. In other words, the control unit 054 which is an example of the display control unit can display pieces of information about a plurality of changes corresponding to a plurality of depth ranges of the MC information on the display unit selectively or side by side. A wider diversity of diagnostic information can be presented by displaying the MC values of respective layers in a comparable manner.

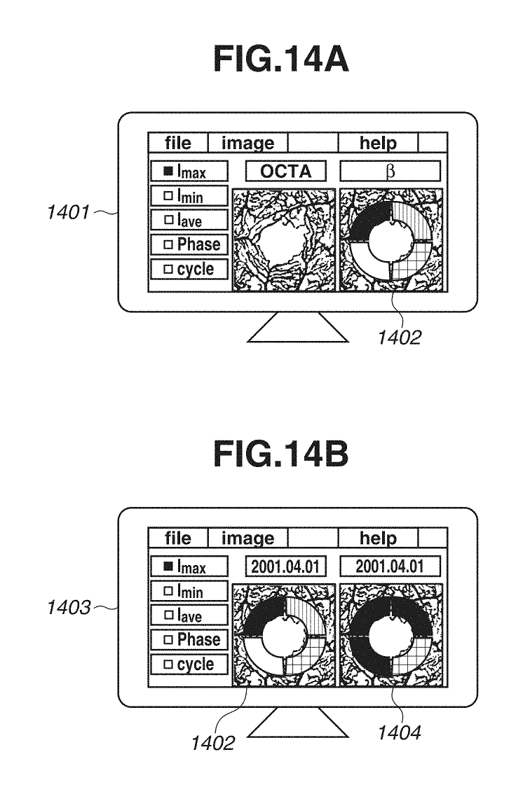

In the foregoing exemplary embodiments, examination data on the same day is mainly used. However, a configuration capable of comparison with data of, for example, one year later, i.e., capable of a follow-up observation is diagnostically effective. In a sixth exemplary embodiment, an apparatus (fundus tracking apparatus) having a fundus tracking function of correcting eye movement to enable measurement of the same region is desirably used because OCTA luminance change information about the same fundus region of the same eye to be examined needs to be obtained. For example, the fundus tracking apparatus refers to a system that detects movement of the fundus of the eye to be examined by calculating correlation between fundus images obtained by a fundus image acquisition unit (SLO) at different times and adjusts the irradiation position of measurement light to cancel the movement so that the target region can be constantly measured. The same retinal region of the same eye to be examined can be scanned by such accurate scanning of the fundus. Operations to be actually performed by the examiner will be described. As illustrated in FIG. 14A, after acquisition of past MC value change information 1402 based on identification (ID) information about the subject, the examiner specifies, for example, a follow-up observation mode to set up specifications for scanning the same region under the same condition as in the past. If the follow-up observation mode is selected, the control unit 054 of FIG. 1B reads apparatus parameters used during the acquisition and generation of the past MC value change information 1402, stored in association with the MC value change information 1402. Examples of the apparatus parameters include a scan pattern and the presentation position of a fixation lamp during imaging, calculation parameters of the MC values, and a specified range of depth for generating an OCTA en face image. The control unit 054 reproduces a state in which data equivalent to the past data can be obtained, and obtains MC value change information according to the foregoing procedure for generating MC value change information. As illustrated in FIG. 14B, the control unit 054 then displays the pieces of MC value information (past MC values 1402 and current MC values 1404) in parallel along with descriptions of the measurement dates and times and the MC value change information, or displays how the statistics of a predetermined ROI change over time. In such a manner, medical information leading to an early diagnosis of ocular circulation can be provided based on temporal changes in the MC value change information about the same subject.

SDOCT-based exemplary embodiments have been described above. However, the present invention is not limited thereto, and similar effects can be provided for swept source OCT (SSOCT), polarization-sensitive OCT, Doppler OCT, line OCT, and full-field OCT (FFOCT).

An exemplary embodiment of the present invention can also be implemented by performing the following processing. The processing includes supplying software (program) for implementing the functions of the foregoing exemplary embodiments to a system or an apparatus via a network or various storage media, and reading and executing the program by a computer (or central processing unit (CPU) or microprocessing unit (MPU)) of the system or apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-209376, filed Oct. 30, 2017, which is hereby incorporated by reference herein in its entirety.

What is claimed is:

1. An image processing apparatus comprising:
an information generation unit configured to generate motion contrast information about substantially a same region of an eye to be examined by using a plurality of pieces of tomographic information obtained by imaging substantially the same region at a predetermined time interval; and
an information acquisition unit configured to obtain information about a change in a motion contract value of at least part of substantially the same region by using a plurality of pieces of the motion contrast information at different times.

2. The image processing apparatus according to claim 1, wherein the information about the change is information about at least one of an amplitude, a period, and a phase of the change in the motion contrast value.

3. The image processing apparatus according to claim 1, further comprising an average processing unit configured to perform average processing on a plane of a motion contrast en face image generated by using information in part of a depth range of the motion contrast information.

4. The image processing apparatus according to claim 3, wherein the average processing unit is configured to perform the average processing on a plurality of areas obtained by dividing the plane of the motion contrast en face image.

5. The image processing apparatus according to claim 4, wherein the plurality of areas includes at least one of a plurality of concentric circular, sector, and arcuate areas substantially about an optic disc or a macular of the eye to be examined.

6. The image processing apparatus according to claim 4, wherein the plurality of areas is obtained by dividing the plane of the motion contrast en face image with a line connecting an optic disc portion and a macular portion of the eye to be examined as a dividing line.

7. The image processing apparatus according to claim 3, further comprising a blood vessel specification unit configured to specify a predetermined number of blood vessels having a large vascular diameter among blood vessels around an optic disc of the eye to be examined,
wherein the average processing unit is configured to determine a dividing line, in a center direction, of at least one of a plurality of concentric circular, sector, and arcuate areas based on an output of the blood vessel specification unit.

8. The image processing apparatus according to claim 1, further comprising a setting unit configured to set a position of at least either one of an optic disc and a macula of the eye to be examined.

9. The image processing apparatus according to claim 1, further comprising an average image generation unit configured to generate an average image of a plurality of motion contrast en face images at different times, the motion contract en face images being generated by using information in part of a depth range of the motion contrast information.

10. The image processing apparatus according to claim 1, further comprising a display control unit configured to display the information about the change on a display unit.

11. The image processing apparatus according to claim 10, wherein the display control unit is configured to display at least either one of an intensity image and a motion contrast en face image of the eye to be examined and the information about the change on the display unit side by side, the motion contrast en face image being generated by using information in part of a depth range of the motion contrast information.

12. The image processing apparatus according to claim 10, wherein the display control unit is configured to display a color image on the display unit, the color image being obtained by superimposing the information about the change as hue on an intensity image or a motion contrast en face image of the eye to be examined, the motion contrast en face image being generated by using information in part of a depth range of the motion contrast information.

13. The image processing apparatus according to claim 10, wherein the display control unit is configured to continuously display a plurality of motion contrast en face images at different times on the display unit, the motion contrast en face images being generated by using information in part of a depth range of the motion contrast information.

14. The image processing apparatus according to claim 11, wherein the display control unit is configured to display a plurality of pieces of information about the change corresponding to a plurality of depth ranges of the motion contrast information on the display unit selectively or side by side.

15. The image processing apparatus according to claim 11, wherein the display control unit is configured to display, on the display unit, a result of comparison between the information about the change and information about a change in the motion contrast value obtained at a different date and time.

16. The image processing apparatus according to claim 1, further comprising an image generation unit configured to generate a motion contrast en face image by using information in part of a depth range of the motion contrast information,
wherein the information acquisition unit is configured to obtain the information about the change by using a plurality of motion contrast en face images at different times.

17. The image processing apparatus according to claim 1, further comprising:
a specification unit configured to specify a depth range in a set of a plurality of pieces of motion contrast information at adjacent positions; and
an image generation unit configured to generate a motion contrast en face image in the specified depth range,
wherein the information acquisition unit is configured to obtain information about the change in a plurality of motion contrast en face images within a predetermined time.

18. An image processing method comprising:
generating motion contrast information about substantially a same region of an eye to be examined by using a plurality of pieces of tomographic information obtained by imaging substantially the same region at a predetermined time interval; and
obtaining information about a change in a motion contrast value of at least part of substantially the same region by using a plurality of pieces of the motion contrast information at different times.

19. A non-transitory computer-readable storage medium storing a program for causing a computer to execute an image processing method, the image processing method comprising:
generating motion contrast information about substantially a same region of an eye to be examined by using a plurality of pieces of tomographic information obtained by imaging substantially the same region at a predetermined time interval; and
obtaining information about a change in a motion contrast value of at least part of substantially the same region by using a plurality of pieces of the motion contrast information at different times.
